(19) United States
(12) Patent Application Publication
(10) Pub. No.: US 2022/0355706 A1
(43) Pub. Date: Nov. 10, 2022

(54) OVERHEAD LINE SYSTEM

(71) Applicant: BRECKNELL, WILLIS & CO. LIMITED, Burton-On-Trent Staffordshire (GB)

(72) Inventor: Brun Lee, Burton-On-Trent Staffordshire (GB)

(21) Appl. No.: 17/622,559

(22) PCT Filed: Jul. 2, 2020
(86) PCT No.: PCT/GB2020/051589

§ 371 Date: Dec. 23, 2021

(30) Foreign Application Priority Data
Jul. 2, 2019 (GB) 1909524.9

(51) Int. Cl. B60M 1/13; B60M 1/22; H01B 9/00

(52) U.S. Cl. CPC B60M 1/135; B60M 1/22; H01B 9/008

(57) ABSTRACT

The present invention provides an improved catenary wire system for an overhead line equipment (OLE) installation. Known OLE installations are prone to sagging and hence require a large number of support structures, which are expensive to install and maintain. These structures also appear “cluttered” and ungainly. The catenary wire system of the present invention comprises a fibre reinforced composite catenary wire configured to suspend a contact wire; and at least one elongate electrically conductive element arranged generally parallel with the catenary wire. It has been found that the catenary wire system of the present invention is able to withstand increased tensions when compared to known OLE installations, which reduces the amount of catenary wire sag, and can thereby reduce the number of support structures required by an OLE installation.

### FIELD OF THE INVENTION

The present invention relates to a catenary wire system for an overhead line equipment installation, an overhead line equipment installation comprising said catenary wire system, a rail-side structure comprising said overhead line equipment installation and a method of installing the same.

### BACKGROUND OF THE INVENTION

Overhead line equipment (OLE) is required to supply electric current to electric rail vehicles, such as electric trains and trams. As shown in FIG. 1, OLE systems 1 typically comprise an overhead electrically conductive contact wire 5 that is configured to contact a pantograph of a rail vehicle and supply electric current.

OLE systems 1 also typically comprise an overhead, longitudinal catenary wire 4 which is configured to suspend the contact wire 5. Connectors 6, such as vertical cables (sometimes referred to as droppers) interconnect the catenary wire 4 and contact wire 5. The catenary wire 4 is, in turn, suspended by a series of support structures 2, 3 which, in rail applications, are typically arranged along the length of the rail track.

Typically, both the contact wire 5 and the catenary wire 4 are made almost entirely from a conductive metallic material, such as copper. However, such systems are heavy and have a tendency to sag. Moreover, the tensioning of such catenary wires is limited, for example to approximately 9 to 24 kN. Therefore, in order to overcome the issues of sagging, in conventional OLE systems, the support structures must be spaced at selected distances, such as approximately 20 to 30 m in street running areas, to try and avoid the sagging of the catenary wire and contact wire below a pre-determined clearance height, typically between 4-6 m above ground.

Large numbers of support structures are expensive to install. Furthermore, the maintenance of overhead line equipment is complicated and expensive, and large numbers of support structures further exacerbates this issue as they increase the maintenance workload for rail-line operators.

Support structures can also often appear “cluttered” and “ungainly” which contributes to visual pollution, particularly in built-up or urban areas.

Furthermore, conventional catenary wire materials also tend to lengthen, and hence sag, during hot weather spells and subsequently require auto-tensioning equipment in order to maintain tension in the catenary wire, which further adds to maintenance time and costs.

Therefore, there exists a need to reduce the installation and maintenance requirements, and associated costs, as well as reducing the visual impact associated with conventional OLE systems.

The present invention seeks to address the problems associated with conventional OLE systems.

### SUMMARY OF THE INVENTION

A first aspect of the present invention provides a catenary wire system for an overhead line equipment (OLE) installation, the catenary wire system is configured to suspend a contact wire via a dropper or spacer, the system comprising a catenary wire and at least one elongate electrically conductive element arranged generally parallel with and spaced from the catenary wire and supported by the catenary wire and configured to be electrically connected to, or form at least a portion of, the contact wire, wherein the catenary wire comprises a fibre reinforced composite material.

In some embodiments, the modulus of elasticity of the catenary wire may be greater than the modulus of elasticity of the at least one conductive element.

In some embodiments, the modulus of elasticity of the catenary wire may be at least 200 GPa.

In some embodiments, the strength to weight ratio of the catenary wire may be greater than the strength to weight ratio of the at least one conductive element.

In some embodiments, the strength to weight ratio of the catenary wire may be at least 750 kNm/kg.

In some embodiments, the catenary wire may be configured to withstand the primary axial tension loads of the OLE installation.

In some embodiments, the at least one conductive element may be configured to support substantially no axial tension loads of the OLE installation.

This provides the advantage of providing a catenary wire system which is able to withstand higher tensions, and is hence less prone to sagging, without increasing the loads placed on the respective support structures. This subsequently allows for increased spacing between support structures when using the catenary wire system according to the first aspect of the invention.

In some embodiments, the tensile strength of the catenary wire may be greater than the tensile strength of the conductive element.

In some embodiments, the tensile strength of the catenary wire may be at least 1 Gpa.

This provides the advantage of further reducing catenary wire sag during use, for example due to plastic deformation of the catenary wire as it is tensioned, which further allows for increased spacing between support structures.

In some embodiments, the coefficient of thermal expansion of the catenary wire may be less than the coefficient of thermal expansion of the conductive element.

In some embodiments, the catenary wire exhibits a coefficient of thermal expansion between −1×10⁻⁶ and 2×10⁻⁶.

This provides the advantage of reducing sag due to thermal expansion of the catenary wire in hot weather conditions.

In some embodiments, the catenary wire may comprise a carbon fibre reinforced composite material.

In other embodiments, the catenary wire may comprise a glass fibre reinforced composite material.

In some embodiments, the catenary wire may be configured to withstand a tension of at least 24 kN in normal use.

In other embodiments, the catenary wire may be configured to withstand a tension of at least 40 kN in normal use.

This further allows for further tensioning of the catenary wire during use, and hence the amount of sag is further reduced, which allows a further increase in spacing between support structures to be obtained.

In some embodiments, the at least one conductive element may comprise a conductive metallic material.

For example, in some embodiments, the conductive metallic material may be copper.

In other embodiments, the conductive element may be a conductive additive, such as carbon black.

In some embodiments, the at least one conductive element may comprise a plurality of conductive elements.

For example, the plurality of conductive elements may be a pair of conductive elements.

In some embodiments, the catenary wire may comprise a core and at least one outer layer surrounding the core, and the outer layer may comprise an electrically insulating material.

This provides the advantage of improved electrical protection.

In some embodiments, the catenary wire may comprise a core and at least one outer layer surrounding the core, and the outer layer may comprise a UV resistant material.

This provides the advantage of reducing the likelihood of UV degradation.

In some embodiments, the catenary wire may comprise a core and at least one outer layer surrounding the core, and the outer layer may comprise a consolidation layer configured to compress the core.

This provides the advantage of improved consolidation at the core.

In some embodiments, the majority of a cross-sectional area of the catenary wire may comprise the core.

In some embodiments, the catenary wire system may further comprise a plurality of connectors configured to secure the at least one conductive element to the catenary wire.

In some embodiments, the plurality of connectors may be configured to allow relative movement between the conductive element and the catenary wire.

This feature helps to relieves stress on the components due to thermal expansion of the conductive elements in warm weather conditions, which in turn provides the further advantage of improved component life and a further reduction in the maintenance burden of the catenary wire system.

In some embodiments, the plurality of connectors may each comprise a clip having a plurality of releasably connectable sections.

This enables the clips to be easily released and engaged during installation and maintenance, and thereby provides the advantage of further reducing installation times, and associated costs.

In some embodiments, the plurality of connectors may comprise nylon.

In some embodiments, the plurality of connectors may be spaced by a distance of two metres or less.

This feature further limits the amount of catenary wire sag, for example due to thermal expansion of the at least one conductive element, which helps to further removes the need for auto-tensioning equipment.

A second aspect of the invention provides an overhead line equipment (OLE) installation comprising a catenary wire system according to the first aspect of the present invention wherein the at least one electrically conductive element is suspended from the catenary wire via a dropper or spacer, the contact wire forming at least a portion of, or being electrically coupled to, the at least one electrically conductive element and being configured to receive electrical power from an electrical power source and a plurality of support structures, each having at least one interconnection configured to secure the catenary wire system between the respective support structures.

In some embodiments, the support structure may comprise a support and a cantilever arm, and the at least one interconnection may be provided at the cantilever arm.

In some embodiments, the plurality of support structures may comprise a composite material.

In some embodiments, the plurality of support structures may comprise a glass fibre reinforced composite material.

In other embodiments, the plurality of support structures may comprise carbon fibre reinforced composite material.

This enables the support structures to resist higher loads without increasing component size/weight. This provides the advantage of allowing for easier installation, thereby reducing installation times and associated costs, as well as further reducing visual “clutter” caused by the OLE installation.

In some embodiments, the at least one interconnection may be configured to allow relative movement between the catenary wire system and the support structure.

This relieves stress on the catenary wire system during movement, for example during windy conditions, which in turn improves the advantage of improved component life, thereby further reducing the maintenance requirements of the installation.

A third aspect of the present invention provides a rail-side structure comprising the overhead line equipment (OLE) installation according to the second aspect of the present invention.

A fourth aspect of the present invention provides a method of installing an overhead line equipment installation comprising the steps of providing a catenary wire system comprising a catenary wire, comprising a fibre reinforced composite material, and at least one elongate electrically conductive element arranged generally parallel with and spaced from the catenary wire and supported by the catenary wire, tensioning the catenary wire, connecting the catenary wire system to a plurality of support structures via an interconnection, suspending the at least one electrically conductive element from the catenary wire via a dropper or spacer and electrically connecting the at least one conductive element as, or to, the contact wire.

This provides the advantage of providing an OLE installation which exhibits a high tension catenary wire, and is hence less prone to sagging, which subsequently allows for increased spacing between support structures.

In some embodiments, the steps of the method according to the fourth aspect of the present invention may be performed sequentially.

In other embodiments the catenary wire system may be tensioned after the catenary wire system has been connected to the plurality of support structures.

In some embodiments, wherein the support structure comprises a composite material, the step of providing the plurality of support structures may comprise pultruding the plurality of support structures.

This provides the advantage of obtaining a high strength support structures to be obtained at low cost.

In some embodiments, the step of providing the catenary wire may comprise manufacturing the catenary wire via filament winding.

In some embodiments, the step of tensioning the catenary wire may comprise super-tensioning the catenary wire to a tension of at least 24 kN.

In some embodiments, the step of tensioning the catenary wire may comprise super-tensioning the catenary wire to a tension of at least 40 kN.

This further allows for increased spacing between support structures.

The term ‘super-tension’ is used herein to refer to tensions at or in excess of 24 kN.

The term ‘dropper’ is used herein to refer to a connecting component between a catenary wire and a contact wire.

### BRIEF DESCRIPTION OF THE DRAWINGS

Embodiments of the invention will now be described with reference to the accompanying drawings, in which: FIG. 1 depicts a side view of an overhead line equipment installation known in the art;

FIG. 2 depicts a side view of an overhead line equipment installation according to an embodiment of the present invention;

FIG. 2A depicts a perspective view of an interconnection between a support structure and a catenary wire system of the overhead line equipment installation illustrated in FIG. 2;

FIG. 3 depicts a perspective view of a catenary wire system according to an alternative embodiment of the present invention;

FIG. 4A depicts a side view of a catenary wire of the catenary wire system illustrated in FIGS. 1 and 3;

FIG. 4B depicts a front view of the catenary wire illustrated in FIG. 4A. FIG. 5 depicts a perspective view of a connector of the catenary wire system illustrated in FIG. 3;

### DETAILED DESCRIPTION OF EMBODIMENT(S)

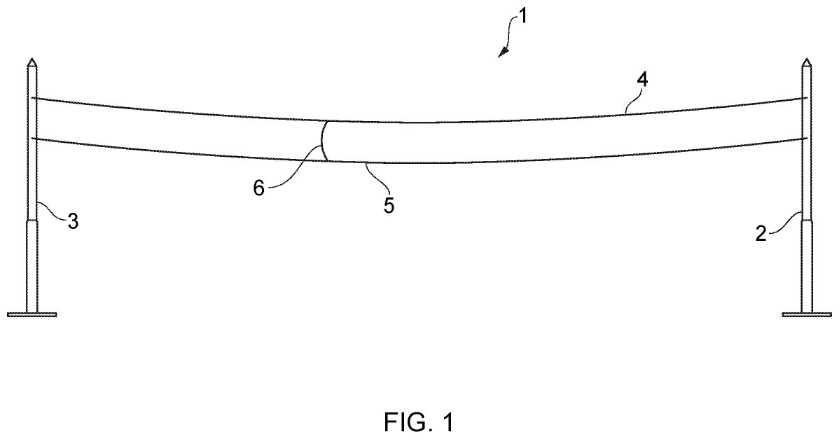

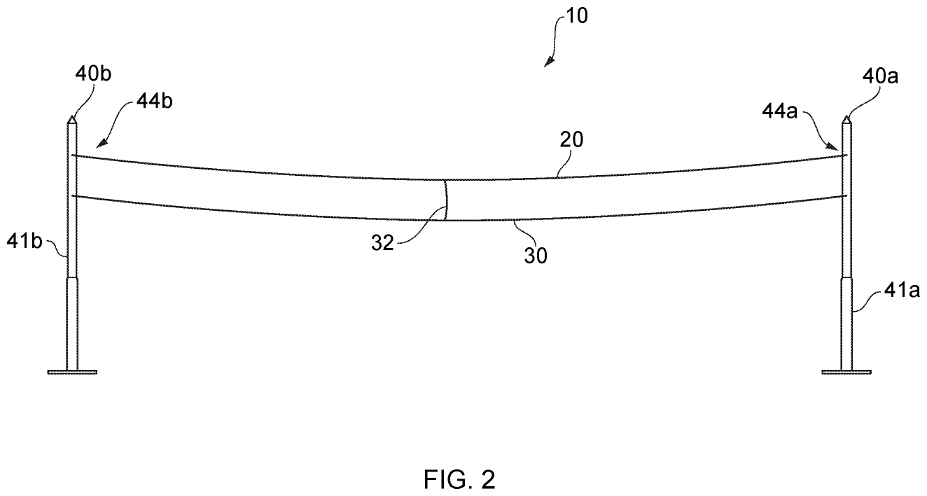

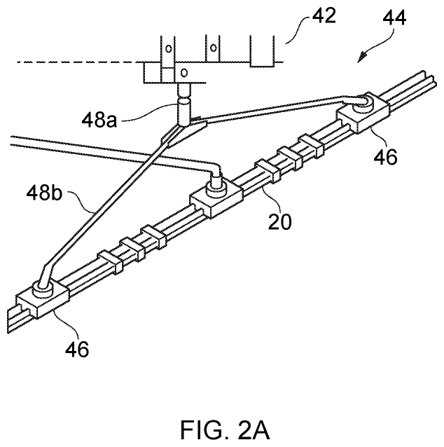

FIG. 2 illustrates an overhead line equipment (OLE) installation 10 according to an embodiment of the present invention.

In the illustrated embodiment, the overhead line equipment installation 10 is a rail-side structure for supplying electrical power to an electric rail vehicle, such as an electric train or a tram. However, in alternative embodiments, the OLE installation may be mounted from a building or any other suitable structure (such as a bridge or tunnel).

The OLE installation 10 comprises a catenary wire system including a catenary wire 20, an electrically conductive element in the form of a contact wire 30 and a pair of support structures 40a, 40b from which the catenary wire system is suspended. The contact wire 30 is further suspended from the catenary wire 20, for example via a dropper 32, to ensure that the contact wire 30 does not “sag” below a pre-determined level.

In the illustrated embodiment, the electrically conductive element of the catenary wire system is provided by the contact wire 30. However, it shall be appreciated that in other embodiments, the catenary wire may comprise its own electrically conductive element which is electrically connected to the contact wire.

The means by which a contact wire 30 can be suspended from a catenary wire 20 are well known in the art and therefore, for the sake of conciseness, shall not be described in any further detail within this application.

The contact wire 30 is primarily formed from a conductive material, such as copper, and is configured to receive electrical power from an electrical power source, such as an electrical feeder or sub-station, via an auto-transformer feeder (ATF) located on the respective support structures 40a, 40b.

The contact wire 30 subsequently transmits the electrical power to an electric rail vehicle, typically via forming an electrical connection with a train/tram pantograph, so as to power said vehicle during operation.

The plurality of support structures 40a, 40b each comprise a support 41 and a cantilever arm 42 extending substantially perpendicular therefrom (see FIG. 2a).

The plurality of support structures 40a, 40b are typically pultruded from a composite material, such as a carbon fibre reinforced composite or a glass fibre reinforced composite. This enables the respective support structures 40a, 40b to resist higher loads, for example from a high tension catenary wire system, without requiring large increases in size. However, it shall be appreciated that in other embodiments, the support structures may be made from any other suitable material, such as metallic materials (e.g. steel or aluminium), and may also be manufactured using any other suitable method.

The support 41 and cantilever arm 42 are typically formed as separate modular components that are coupled together to form the support structure. However, it shall be appreciated that in other embodiments, the support structure may alternatively be formed as a unitary structure.

The pair of support structures 40a, 40b each comprise a respective interconnection 44a, 44b configured to secure the catenary wire system 20 to the respective support structures 40a, 40b. In the illustrated embodiment, as shown in FIG. 2A, the interconnection 44 is located at the cantilever arm 42. However, in other embodiments, it shall be appreciated that the interconnection may be provided at any other suitable location.

The interconnection 44 comprises a plurality of stitch clips 46 which are configured to engage the catenary wire 20. The respective stitch clips 46 are subsequently connected to the cantilever arm 42 via a series of mechanical linkages 48a, 48b, thereby forming the interconnection 44.

The mechanical linkages 48a, 48b are configured to permit relative movement between the support structures 40a, 40b and the catenary wire 20. By permitting relative movement between the support structure 40a, 40b and the catenary wire 20, the transfer of stress acting on the support structure 40a, 40b and the catenary wire 20, for example due to adverse weather conditions, is reduced which helps to improve the component life of the OLE installation and reduce maintenance costs associated therewith. However, it shall be appreciated that in other embodiments, any other suitable type of interconnection may be used.

The cantilever arm 42 may further comprise an isolator configured to electrically isolate the support 41 and other components of the support structure 40 from the electrical current passing through the contact wire 30. However, in other embodiments, the isolator may be provided at another part of the OLE installation 10.

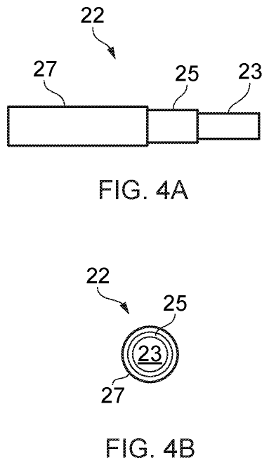

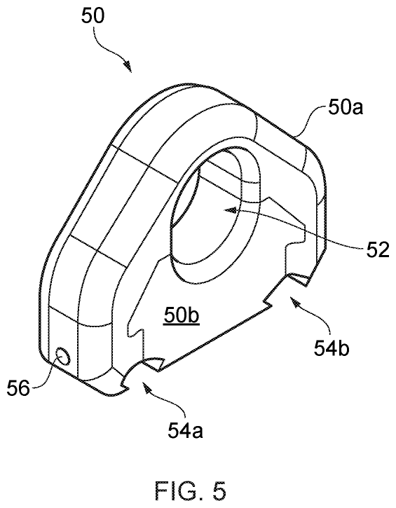

The catenary wire 20 of the illustrated embodiment is made up of a core 23, an intermediate layer 25 and an outer layer 27, as shown in FIG. 4. However, in other embodiments, it shall be appreciated that the catenary wire may be of any other suitable construction. For example, the intermediate and/or outer layers may be omitted.

The core 23 is made from a composite material, typically a carbon fibre reinforced composite or a glass fibre reinforced composite, and forms a majority of the cross-sectional area of the catenary wire 20. In the illustrated embodiment, the core 23 is made from a carbon fibre reinforced composite, such as Ceflex, although it shall be appreciated that any other suitable composite materials may be used.

The intermediate layer 25 is a consolidation layer and is configured to compress the material of the core 23, which helps to improve consolidation at the core 23.

The outer layer 27 is an insulator layer and therefore provides the catenary wire 20 with improved electrical protection. In the illustrated embodiment, the outer layer 27 is made from a polymeric material, such as cross-linked polyethylene (XLPE), and is configured to act effectively as an insulator for voltages up to 1000V.

In addition to providing insulating properties, the outer layer 27 of the illustrated embodiment also comprises a UV resistant material which helps to better reduce degradation of the catenary wire 20 over time due to the effects of UV exposure, thereby helping to further reduce the maintenance burden of the catenary wire system 20. However, in other embodiments, this feature may be omitted.

The catenary wire 20 of the illustrated embodiment is manufactured to withstand a tension of at least 24 kN, and is typically manufactured to withstand a tension of at least 40 kN in normal use. Consequently, the catenary wire 20 according to the illustrated embodiment is capable of being “super-tensioned”.

Conversely, known catenary wire systems generally can only withstand tensions that are approximately half of this value, typically in the region of 20 kN. Since super-tensioned catenary wires provide stiffer catenary support compared to their regularly tensioned counterparts, super-tensioned catenary wires are less prone to sagging and hence require fewer support structures since the distance between support structures can be increased. This allows the present invention to reduce installation and maintenance costs since the number of support structures that must be installed and maintained for a given length of OLE is reduced. Furthermore, by reducing the number of support structures, the visual impact of the OLE is also reduced.

In the illustrated embodiment, the catenary wire 20 exhibits a Young's modulus (i.e. modulus of elasticity) of at least 200 GPa. In the illustrated embodiment, the Young's modulus of the catenary wire 20 is primarily provided by the carbon fibre reinforced composite core. However, it shall be appreciated that in other embodiments, any other suitable composite material exhibiting a Young's modulus of 200 GPa or higher may be used.

By providing a catenary wire 20 having a high Young's modulus, i.e. a catenary wire that is not prone to stretching due to mechanical tension, any stretching of the catenary wire 20 can be minimised, which helps to reduce the occurrence of “sagging”. As such, a stiffer catenary support is provided requiring fewer support structures since the distance between support structures can be increased.

In the illustrated embodiment, the catenary wire 20 exhibits a strength to weight ratio of at least 750 kNm/kg. In the illustrated embodiment, these properties are primarily provided by the carbon fibre reinforced composite core. However, it shall be appreciated that in other embodiments, any other suitable composite material exhibiting a strength to weight ratio of 750 kNm/kg or higher may be used.

By providing a catenary wire 20 having a high strength to weight ratio, the weight (and therefore the associated loads) placed upon the support structures can be minimised, which helps to further reduce the number of support structures required.

The catenary wire 20 also typically exhibits a tensile strength of 1 Gpa or higher. In the case of the illustrated embodiment, these properties are provided primarily by the carbon fibre reinforced composite core 23. However, it shall be appreciated that in other embodiments, the aforementioned tensile strength may be provided by any other suitable composite material. This feature helps to further reduce the likelihood of the catenary wire 20 being stretched, for example due to plastic deformation, and hence sag during use.

The catenary wire 20 of the present invention also exhibits a coefficient of thermal expansion between −1×10⁻⁶ and 2×10⁻⁶, which is again provided by the carbon fibre reinforced composite core 23 of the illustrated embodiment. By providing a catenary wire 22 having a low coefficient of thermal expansion, i.e. between −1×10⁻⁶ and 2×10⁻⁶, thermal expansion of the catenary wire 22 during warm weather conditions, along with the associated “sagging” caused by said expansion, is reduced. This reduces the need for auto-tensioning equipment for maintaining tension in the catenary wire 20, and, as such, the installation and maintenance workload associated with the OLE, as well as the visual impact of the OLE, is further reduced.

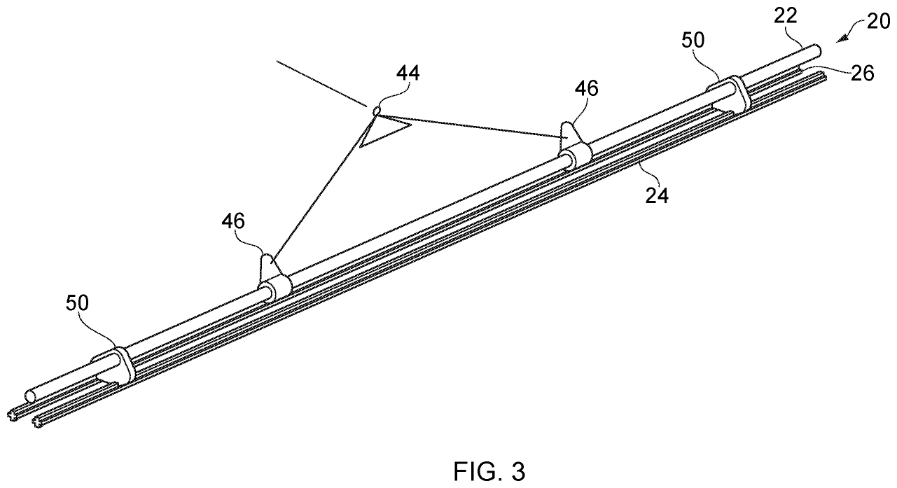

A catenary wire system according to an alternative embodiment of the present invention shall now be described with reference to FIG. 3.

The catenary wire system illustrated in FIG. 3 comprises a catenary wire 22 and a pair of elongate electrically conductive elements 24, 26, which are arranged generally parallel with the catenary wire 22 along its length and form respective contact wires for transmitting electrical power to an electric rail vehicle. The conductive elements 24, 26 typically comprise a conductive metallic material, such as copper. However, it shall be appreciated that, in other embodiments, any other suitable material may be used. It shall also be appreciate that in other embodiments, the conductive elements 24, 26 supported by the catenary wire 22 may instead be electrically connected to a separate contact wire, rather than forming the contact wire per se.

Furthermore, it shall also be appreciated that whilst the catenary wire system of the illustrated embodiment is described as having a pair of conductive elements, in other embodiments the catenary wire system may comprise a single conductive element or may comprise more than two conductive elements.

The conductive elements 24, 26 are secured to the catenary wire 22 via a plurality of connectors. In the illustrated embodiment, the plurality of connectors are provided in the form of a plurality of support clips 50, as shown in FIG. 5, each having a respective opening 52 for receiving the catenary wire 22 and a pair of grooves 54a, 54b for receiving and securing the conductive elements 24, 26 respectively.

The opening 52 and respective grooves 54a, 54b of the support clip are sized to be larger than the corresponding catenary wire 22 and conductive elements 24, 26 received therein. This allows for some degree of relative movement between the catenary wire 22 and the conductive elements 24, 26 during use, which helps to reduce the amounts of stress exerted on the catenary wire 22 due to thermal expansion of the conductive elements 24, 26 during warm weather conditions.

The support clips 50 are formed in two parts, and therefore comprise a first portion 50a and a second portion 50b, which are releasably connected via a pin 56. When the pin 56 is removed, the second portion 50b of the support clip 50 can be easily de-coupled from the first portion 50a to allow access to the opening 52 for receiving the catenary wire 22. Once the catenary wire 22 is located within the opening 52, the second portion 50b of the support clip can be re-coupled with the first portion 50a and the pin 56 re-engaged to secure the catenary wire 22 within the opening 52. This enables the support clips 50 to be easily opened and closed during installation and maintenance.

Typically, the plurality of support clips are made of nylon. However, it shall be appreciated that any other suitable material may be used. It shall also be appreciated that in other embodiments, any other suitable connector type may be used. The plurality of connectors are typically spaced along the catenary wire 22 at two metre intervals. This provides sufficient support for the conductive elements 24, 26 such that any ‘sagging’ of the conductive elements 24, 26, for example due to thermal expansion during hot weather conditions, will still not be sufficient to cause the catenary wire system 20 to drop below a pre-determined minimum height (typically between 4-6 m).

Therefore, when using this spacing, no auto-tensioning equipment is required.

A method of installing an OLE installation according to the present invention shall now be described with reference to the above mentioned figures.

In a first step, the catenary wire system and support structures 40a, 40b are provided. In the illustrated embodiment, the catenary wire 22 is manufactured via filament winding, whereas the plurality of support structures 40a, 40b are manufactured via pultrusion. Such methods enable lightweight and high strength components to be obtained at a relatively low cost. However, it shall be appreciated that other manufacturing methods may be used.

Once the plurality of support structures 40a, 40b have been manufactured, the support structures 40a, 40b are installed at a required location. As has been discussed previously, this location may be a rail-side location, or alternatively, the support structures 40a, 40b may be mounted from a building or any other suitable structure (such as a bridge or tunnel).

A desired tensile load is then applied to the catenary wire 22 in order to sufficiently tension the catenary wire system. Typically, the catenary wire 22 is super-tensioned to a tension of 40 kN. However, in other embodiment, the tension in the catenary wire 20 may be less.

Once the catenary wire 22 has reached the desired tension levels, the catenary wire system is then connected to the respective support structures 40a, 40b via the respective interconnections 44a, 44b, such that the desired tension in the catenary wire 22 is maintained.

Once the catenary wire system has been connected to the respective support structures 40a, 40b, the electrically conductive elements 24, 26 can be electrically connected to a power supply to complete the OLE installation.

Although the invention has been described above with reference to one or more preferred embodiments, it will be appreciated that various changes or modifications may be made without departing from the scope of the invention as defined in the appended claims.

1. A catenary wire system for an overhead line equipment (OLE) installation, the catenary wire system is configured to suspend a contact wire via a dropper or spacer, the system comprising:
a catenary wire; and
at least one elongate electrically conductive element arranged generally parallel with and spaced from the catenary wire and supported by the catenary wire and configured to be electrically connected to, or form at least a portion of, the contact wire,
wherein the catenary wire comprises a fibre reinforced composite material.

2. The catenary wire system according to claim 1, wherein the modulus of elasticity of the catenary wire is greater than the modulus of elasticity of the at least one conductive element.

3. The catenary wire system according to claim 2, wherein the modulus of elasticity of the catenary wire is at least 200 GPa.

4. The catenary wire system according to claim 1, wherein the strength to weight ratio of the catenary wire is greater than the strength to weight ratio of the at least one conductive element.

5. The catenary wire system according to claim 4, wherein the strength to weight ratio of the catenary wire is at least 750 kNm/kg.

6. The catenary wire system according to claim 1, wherein the catenary wire is configured to withstand the primary axial tension loads of the OLE installation.

7. The catenary wire system according to claim 1, wherein the at least one conductive element is configured to support substantially no axial tension loads of the OLE installation.

8. The catenary wire system according to claim 1, wherein the tensile strength of the catenary wire is greater than the tensile strength of the at least one conductive element.

9. The catenary wire system according to claim 8, wherein the tensile strength of the catenary wire is at least 1 Gpa.

10. The catenary wire system according to claim 1, wherein the coefficient of thermal expansion of the catenary wire is less than the coefficient of thermal expansion of the at least one conductive element.

11. The catenary wire system according to claim 10, wherein the catenary wire exhibits a coefficient of thermal expansion between −1×10⁻⁶ and 2×10⁻⁶.

12. The catenary wire system according to claim 1, wherein the catenary wire comprises a glass fibre and/or carbon fibre reinforced composite material.

13. The catenary wire system according to claim 1, wherein the catenary wire is configured to withstand a tension of at least 24 kN in normal use, and preferably wherein the catenary wire is configured to withstand a tension of at least 40 kN in normal use.

14. The catenary wire system according to claim 1, wherein the at least one conductive element comprises a conductive metallic material, and preferably wherein the at least one conductive element comprises copper.

15. The catenary wire system according to claim 1, wherein the catenary wire comprises a core and at least one outer layer surrounding the core, and wherein the outer layer comprises an electrically insulating material.

16. The catenary wire system according to claim 1, wherein the catenary wire comprises a core and at least one outer layer surrounding the core, and wherein the outer layer comprises a UV resistant material.

17. The catenary wire system according to claim 15, wherein the majority of a cross-sectional area of the catenary wire comprises the core.

18. The catenary wire system according to claim 1, wherein the catenary wire system further comprises a plurality of connectors configured to secure the at least one conductive element to the catenary wire, and wherein the plurality of connectors are configured to allow relative movement between the conductive element and the catenary wire.

19. The catenary wire system according to claim 1, wherein the catenary wire system further comprises a plurality of connectors configured to secure the at least one conductive element to the catenary wire, and wherein the plurality of connectors each comprise a clip having a plurality of releasably connectable sections.

20. The catenary wire system according to claim 18, wherein the plurality of connectors are spaced by a distance of two metres or less

21. An overhead line equipment (OLE) installation comprising:
a catenary wire system according to claim 1;
wherein the at least one electrically conductive element is suspended from the catenary wire via a dropper or spacer, the contact wire forming at least a portion of, or being electrically coupled to, the at least one electrically conductive element and being configured to receive electrical power from an electrical power source; and
a plurality of support structures, each having at least one interconnection configured to secure the catenary wire system between the respective support structures.

22. The overhead line equipment installation according to claim 21, wherein the plurality of support structures comprise a composite material, and preferably wherein the plurality of support structures comprise a glass fibre and/or carbon fibre reinforced composite material.

23. A rail-side structure comprising the overhead line equipment (OLE) installation according to claim 21.

24. A method of installing an overhead line equipment installation comprising the steps of:
providing a catenary wire system comprising a catenary wire, comprising a fibre reinforced composite material, and at least one elongate electrically conductive element arranged generally parallel with and spaced from the catenary wire and supported by the catenary wire;
tensioning the catenary wire;
connecting the catenary wire system to a plurality of support structures via an interconnection;
suspending the at least one electrically conductive element from the catenary wire via a dropper or spacer; and
electrically connecting the at least one conductive element as, or to, the contact wire.

25. The method according to claim 24, wherein the step of tensioning the catenary wire comprises super-tensioning the catenary wire to a tension of at least 24 kN, and preferably wherein the step of tensioning the catenary wire comprises super-tensioning the catenary wire to a tension of at least 40 kN.
